(19) United States
(12) Patent Application Publication
(10) Pub. No.: US 2016/0091674 A1
(43) Pub. Date: Mar. 31, 2016

(54) ANGLED-POLISHED CONNECTOR TERMINATIONS IN MULTIMODE APPLICATIONS

(71) Applicant: Virtual Instruments Corporation, San Jose, CA (US)

(72) Inventors: Rama Vuppuladhadium, San Jose, CA (US); Chi-Luen Wang, Pleasanton, CA (US); Jeff Chung, Sunnyvale, CA (US)

(21) Appl. No.: 14/866,442

(22) Filed: Sep. 25, 2015

Related U.S. Application Data
(60) Provisional application No. 62/057,143, filed on Sep. 29, 2014.

(51) Int. Cl. G02B 6/38; H04B 10/079

(52) U.S. Cl. CPC G02B 6/3885; G02B 6/3831; G02B 6/3893; G02B 6/3863; H04B 10/07955; H04B 10/0793

(57) ABSTRACT

A traffic access point (TAP) includes a first angle polished multimode multiple-fiber push-on (MPO) termination, a second angle polished multimode MPO termination, and multiple angle polished LC terminations. At the least, the first and second angle polished multimode MPO terminations are each coupled to a key aligned adapter.

### CROSS REFERENCE TO RELATED APPLICATION

This application claims the benefit of U.S. Provisional Application No. 62/057,143, filed Sep. 29, 2014, which is incorporated by reference herein in its entirety.

### BACKGROUND

1. Technical Field

The described embodiments pertain in general to fiber optics, an in particular to angle-polished connector terminations in multimode applications.

2. Description of Related Art

As the network connections in datacenters increase, parallel optics technology, specifically the multiple-fiber push-on (MPO) technology, has proven to provide practical solutions as it allows for an increase of fiber density in a network. In incorporating MPO technology, various combinations of connectors are used in a network. The combinations include Lucent Connector (LC) to LC, LC to MPO fan out, and MPO to MPO cable connectors. These interconnects play an important role in the network performance. For example, the interconnects decide whether the insertion loss (IL) exceeds the attenuation budget and the return loss/back reflection, which affects the amount of noise. As the technology migrates, for example, to 40/100 Gigabit Ethernet, the components in parallel optical links (MPOs) need to reach the highest performance requirements in order to achieve the desired bandwidth with acceptable bit error rates and confidence levels. For example, this is important for a system (e.g., a monitoring probe) that monitors a data network at higher rates, where the system will be using a very low percentage of the input power (e.g., in the range of 20% to 30%) to monitor the performance of a data network.

### SUMMARY

The described embodiments provide a traffic access point (TAP) that includes a first multimode multiple-fiber push-on (MPO) termination, a second multimode MPO termination, and multiple LC terminations. Each of the terminations is angle polished. Additionally, at the least, the first and second multimode MPO terminations are each coupled to a key aligned adapter.

When the TAP receives a signal transmitted by a storage array and destined for a server through the first angle polished multimode MPO termination, the TAP diverts a portion of the signal to a monitoring system. The TAP outputs the diverted portion of the signal to the monitoring system through the second angle polished multimode MPO termination. The remainder of the signal is output through an angle polished LC termination to the server.

Similarly, when the TAP receives a signal from the server destined for the storage array through an angle polished LC, the TAP diverts a portion of the signal to the monitoring system through the second angle polished multimode MPO termination. The remainder of the signal is output through the second angle polished multimode MPO termination for receipt by the storage array.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

Figure (FIG. 1 illustrates a traffic access point (TAP) in a storage area network (SAN) according to one embodiment.

FIG. 2A illustrates soak test results for a TAP with all physical contact (PC) LC terminations according to one embodiment.

FIG. 2B illustrates soak test results for a TAP with all PC multiple-fiber push-on (MPO) terminations according to one embodiment.

FIG. 3A illustrates PC terminations according to one embodiment.

FIG. 3B illustrates angle polished terminations according to one embodiment.

FIG. 4 illustrates a layout of a TAP with angle-polished physical contact (APC) terminations according to one embodiment.

FIG. 5 illustrates key opposed angle polished terminations according to one embodiment.

FIG. 6 illustrates key aligned angle polished terminations according to one embodiment.

FIG. 7 illustrates key aligned angle polished terminations according to another embodiment

FIG. 8 illustrates cable connection between entities of a storage area network (SAN) according to one embodiment.

FIG. 9 illustrates a plot of bit error rate (BER) versus received power for APC MPO terminations and PC MPO terminations according to one embodiment.

FIG. 10A shows the results of a stressed soak test at a received power of −13 dBm according to one embodiment.

FIG. 10B shows the results of a stressed soak test at a received power of −13.5 dBm according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

The figures use like reference numerals to identify like elements. A letter after a reference numeral, such as “114A,” indicates that the text refers specifically to the element having that particular reference numeral. A reference numeral in the text without a following letter, such as “114,” refers to any or all of the elements in the figures bearing that reference numeral (e.g. “114” in the text refers to reference numerals “114A,” “114B,” and/or “1114C” in the figures).

### DETAILED DESCRIPTION

A traffic access point (TAP) is a hardware device inserted in a network, where the TAP diverts a portion of signals being exchanged between the systems of the network. These diverted signals give insight into the true performance, health and utilization of a network. By obtaining information about the performance of a network, system-wide latency can be reduced, network outages can be prevented, and resource utilization can be dramatically improved.

FIG. 1 illustrates a TAP 110 in a storage area network (SAN) 110 according to one embodiment. The SAN 100 includes a storage array 102, a server 104, fibre channel (FC) switches 106, a monitoring system 108, and the TAP 110. Although the illustrated SAN 100 includes a limited number of each entity, it should be understood that in other embodiments the SAN 100 can include more of each entity (e.g., additional storage arrays 102 and servers 104) and additional components (e.g., fiber patch panels).

The storage array 102 is a storage system that stores data. When the storage array 102 receives a request from the server 104 to store data, the storage array 102 stores the data according to the request. When the storage array 102 receives a request from the server 104 for stored data, the storage array 102 retrieves the requested data and transmits it to the server 104. The server 104 is a computing system that has access to the storage capabilities of the storage array 102. The server 104 may provide data to the storage array 102 for storage and may retrieve stored data from the storage array 102.

The FC switches 106 are network switches compatible with the FC protocol. The FC switches 106 connect the storage array 102 to the server 104 by receiving, processing, and forwarding data exchanged between the storage array 102 and the server 104.

The monitoring system 108 receives signals diverted by the TAP 110. In one embodiment, the monitoring system 108 is the VirtualWisdom SAN Performance Probe provided by Virtual Instruments Corporation of San Jose, Calif. The monitoring system 108 analyzes the signals diverted by the TAP 110 and based on the signals generates data about the SAN 100. For example, the generated data may include: data transmission rates, read exchange completion times, write exchange completion times, and average input output operations per second.

The TAP 110 receives signals exchanged between the storage array 102 and the server 104 and diverts a portion of the signals to the monitoring system 108. In one embodiment, the signals received by the TAP 110 are fiber optic signals. When the TAP 110 receives a signal transmitted by the server 104 and destined for the storage array 102, the TAP 110 splits the signal and outputs a portion of the signal (e.g., 30% of the light) to monitoring system 108 and the remainder of the signal (e.g., 70% of the light) to the FC switches 106 for forwarding to the storage array 102. Similarly, when the TAP 110 receives a signal transmitted by the storage array 102 and destined for the server 104, the TAP 110 outputs a portion of the signal to monitoring system 108 and the remainder of the signal to the server 104.

The TAP 110 includes terminations that allow it to be connected to the entities of the SAN 100 (one or more terminations for connecting the TAP 110 to the server 104, one or more terminations for connecting the TAP 110 to the monitoring system 108, and one or more terminations for connecting the TAP 110 to the storage array 102 through the FC switches 106). The TAP 110 may include Lucent Connector (LC) and/or multiple-fiber push-on (MPO) terminations.

When monitoring a 30% diverted TAP signal @ 8 G fiber channel and @ 10 G Ethernet channel, it was determined that a bit error rate (BER) performance of the diverted signal was degraded when the TAP 110 included physical contact (PC) MPO terminations compared to when the TAP 110 included all PC LC terminations. In both cases the same set of small form-factor pluggable (SFP) transceivers with similar test conditions were used.

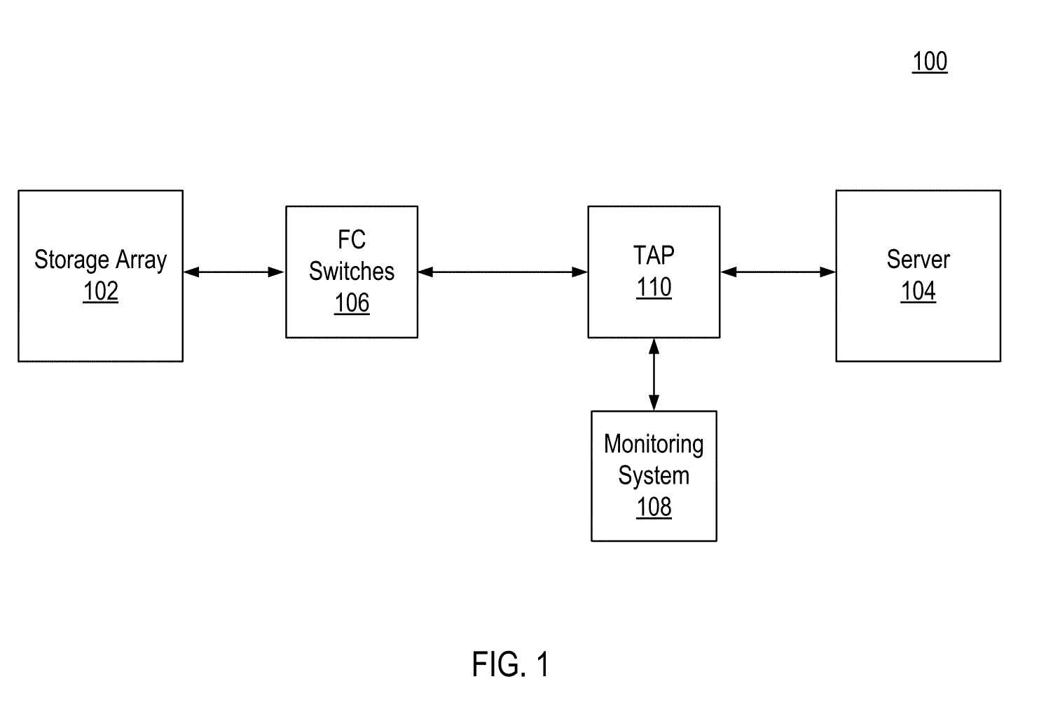

Additionally, a soak test on a TAP 110 with PC MPO terminations can only run up to eight hours without encoding errors (e.g., up to BER of “1 E-14” with a confidence level of 95%). However, a TAP 110 with all PC LC terminations can run longer hours in excess of 15 hours with a BER of “8 E-14 to 1 E-15” with no issue. FIG. 2A illustrates soak test results after 15 hours with all PC LC terminations and FIG. 2B illustrates the soak test results after 15 hours with PC MPO terminations. In FIG. 2A there is no accumulated BER 202 after the 15 hours with the LC terminations. However, FIG. 2B illustrates that with PC MPO terminations, the accumulated BER 204 is “3.9 E-13” and “229” bit errors 206 occurred out of “5.87 E+14” bits read 208.

Hence, a TAP 110 with PC MPO terminations does not perform as well as a TAP 110 with all PC LC terminations. However, including MPO terminations in a TAP 110 is important in order for the TAP 110 to be able to support more fibers. In order to improve the performance of a TAP 110 with MPO terminations, the terminations were angle polished without disturbing the polarity of the terminations.

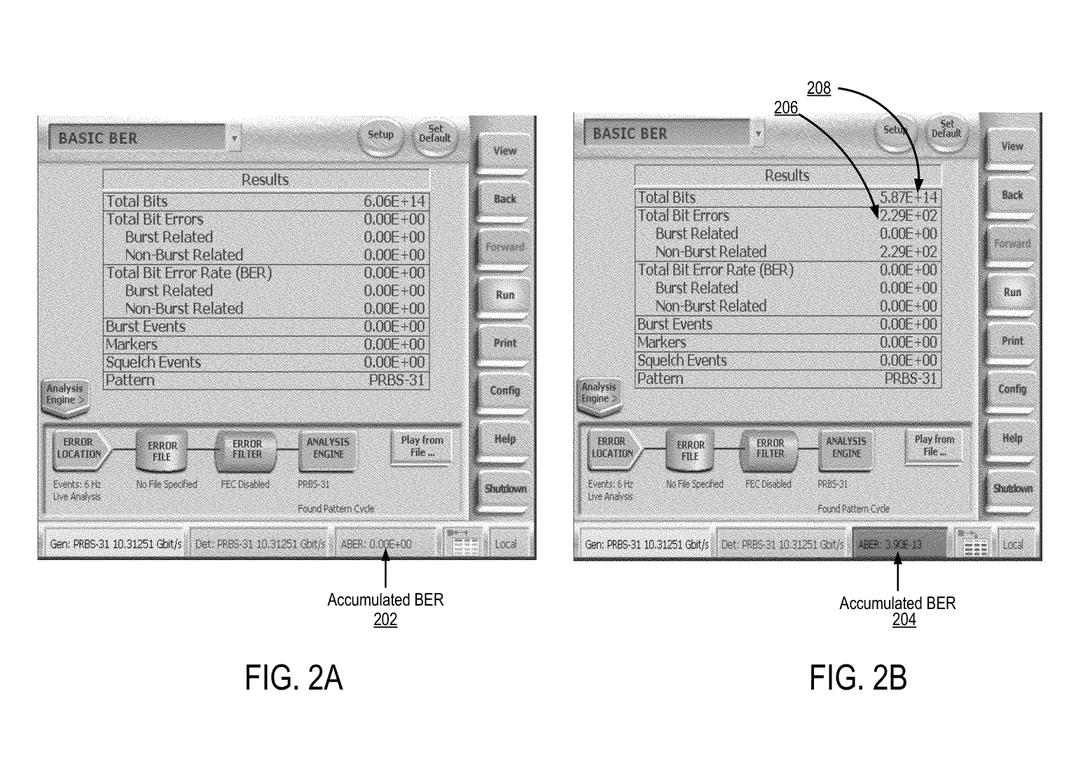

Angle polishing the terminations (e.g., 8 degree angle polish) allows for less light to reflect back up the fiber toward the source (i.e., reduces return loss). For example, FIG. 3A illustrates two PC terminations 302A and 302B. PC termination 302A includes PC ferrule 308A and PC termination 302B includes PC ferrule 308B. Because the PC ferrules 308A and 308B are relatively flat, when light 304 is exchanged, there will be some light reflection 304 towards the source. However, as illustrated by FIG. 3B if the ferrules 310A and 310B are angle polished, when light 304 is exchanged, less light 306 reflects back towards the source because of the angling. Less reflectance means less noise/jitter. Thus, angle polishing the terminations improves the return loss on the terminations and the relative intensity noise-ratio (RIN), thereby by improving the end to end performance by about one dB (or more) and further lowering the BER to about “1 E-15.” This approach delivers reliable and improved performance at higher speed for data monitoring applications. As the data rate goes to 40 and 100G Ethernet, it is important to improve the system performance by reducing the return loss and the RIN, which improves the BER performance.

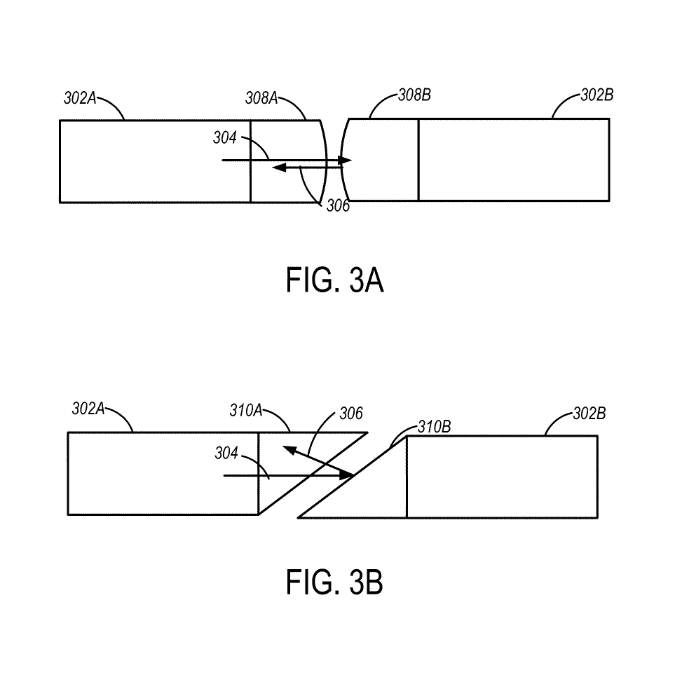

FIG. 4 illustrates a layout of TAP 110 with angle-polished physical contact (APC) terminations according to one embodiment. The TAP 110 includes at least two APC multimode MPO terminations 402A and 402B (also referred to as angled MPO terminations or angle polished MPO terminations) and six APC duplex multimode LC terminations 404A-404F (also referred to as angled duplex LC terminations or angle polished LC terminations). Each termination includes multiple fibers. In other embodiments, the TAP 110 may include additional MPO terminations 402 and more or less LC terminations. In other embodiments, the LC terminations 404A-404F may be PC instead of APC.

Angled MPO termination 402A is coupled to key aligned adapter 406A and through MPO termination 402A the TAP 110 exchanges signals with the monitoring system 108 (e.g., outputs diverted signals). The key aligned adapter 406A allows cable connections from the monitoring system 108 to connect with the angled MPO termination 402A. Angled MPO termination 402B is coupled to key aligned adapter 406B and through MPO termination 402B the TAP 110 receives signals transmitted by the storage array 102 and destined for the server 104. Additionally, through angled MPO termination 402B the TAP 110 outputs a portion of a signal (e.g., 70% or 80%) received by the TAP 110 and destined for the storage array 102.

The angled duplex LC terminations 404A-404F are coupled to key opposed adapters 408A-408F respectively. The key opposed adapters 408A-408F allow cable connections from the server 104 to connect with the LC terminations 404A-404F. Through the angled duplex LC terminations 404A-404F, the TAP 110 receives signals transmitted by the server 104 and destined for the storage array 102. Additionally, through the angled duplex LC terminations 404A-404F, the TAP 110 outputs a portion of a signal transmitted by the storage array 102 and destined for the server 104.

When the TAP 110 receives a signal transmitted by the storage array 102 and destined for the server 104 through the angled MPO termination 402B, a coupler/splitter included in the TAP 110 diverts a portion of the signal (e.g., 30% or 20% of the signal) to the angled MPO termination 402A. The remainder of the signal (e.g., 70% or 80% of the signal) is output to the server 104 through an angled duplex LC termination 404. Similarly, when the TAP 110 receives a signal from the server 104 through an angled duplex LC termination 404, a coupler included in the TAP 110 diverts a portion of the signal to the angled MPO termination 402A and outputs the remainder of the signal through the angled MPO termination 402B.

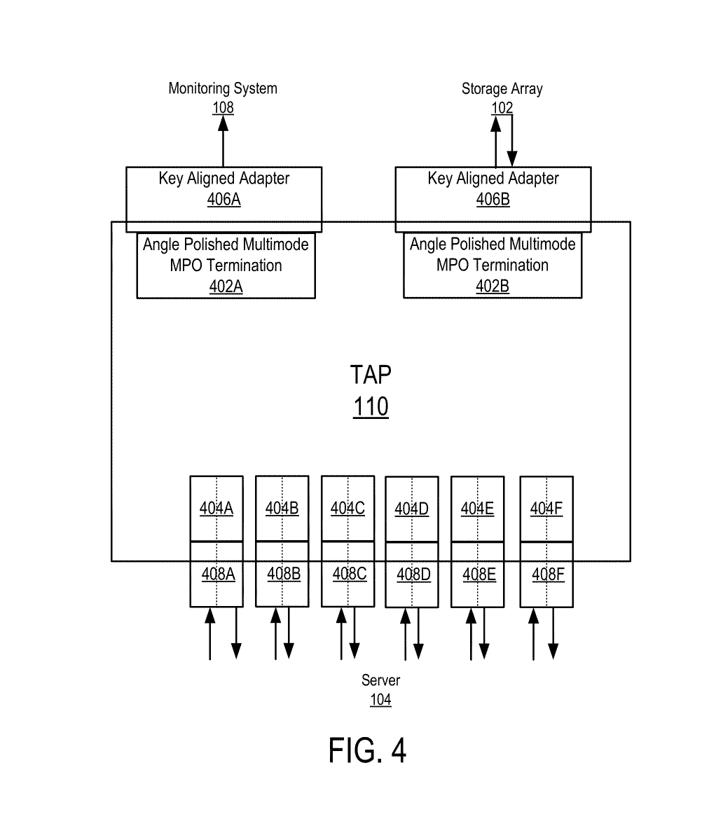

Conventionally with an angled termination, the angle of the termination is aligned with the key. For example, FIG. 5 illustrates two angled terminations 502A and 502B. Termination 502A includes an angled ferrule 504A and a key 506A. Termination 502B also includes an angled ferrule 504B and a key 506B. The angle of each ferrule 504 is aligned with key 506, meaning that they key 506 is on the termination 502 side where the ferrule 504 includes a wider edge that slopes down at an angle towards the perpendicular edge. A key opposed adapter 502 allows the two terminations to come together because a key opposed adapter 502 requires the keys 506 to be opposite to each other (one key up and one key down).

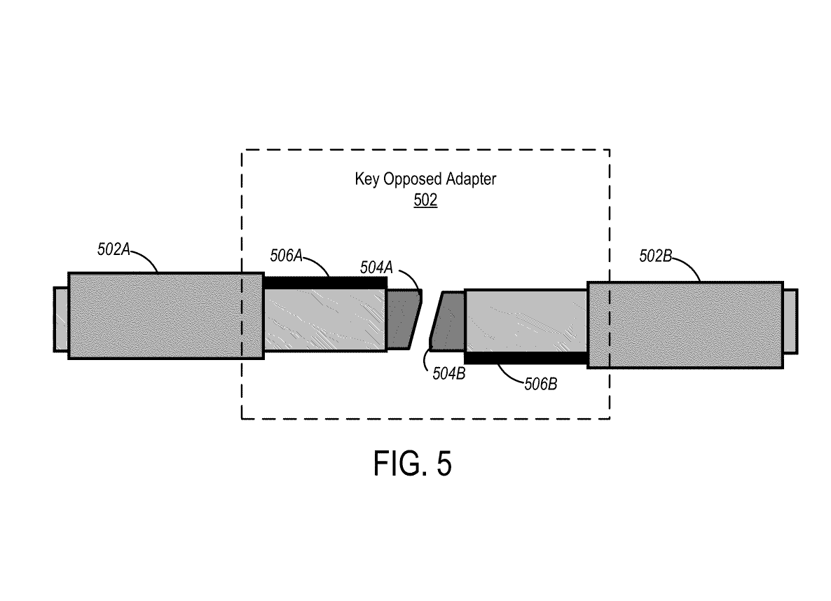

However, in the embodiment of FIG. 4, the angled MPO terminations 402A and 402B are coupled to key aligned adapters 406A and 406B respectively. Key aligned adapters require that the keys of the terminations be on the same side (both keys up or both keys down). FIG. 6 illustrates two terminations 602A and 602B, where the angles of the ferrules 604A and 604B are aligned with their respective key 606A and 606B. A key aligned adapter 608 is used in this example and as a result both keys 606 are on the same side. However, since the ferrules 604 are angled on the same side, the ferrules 604 will not align (will not fully come together) and there will be a gap between the ferrules 604.

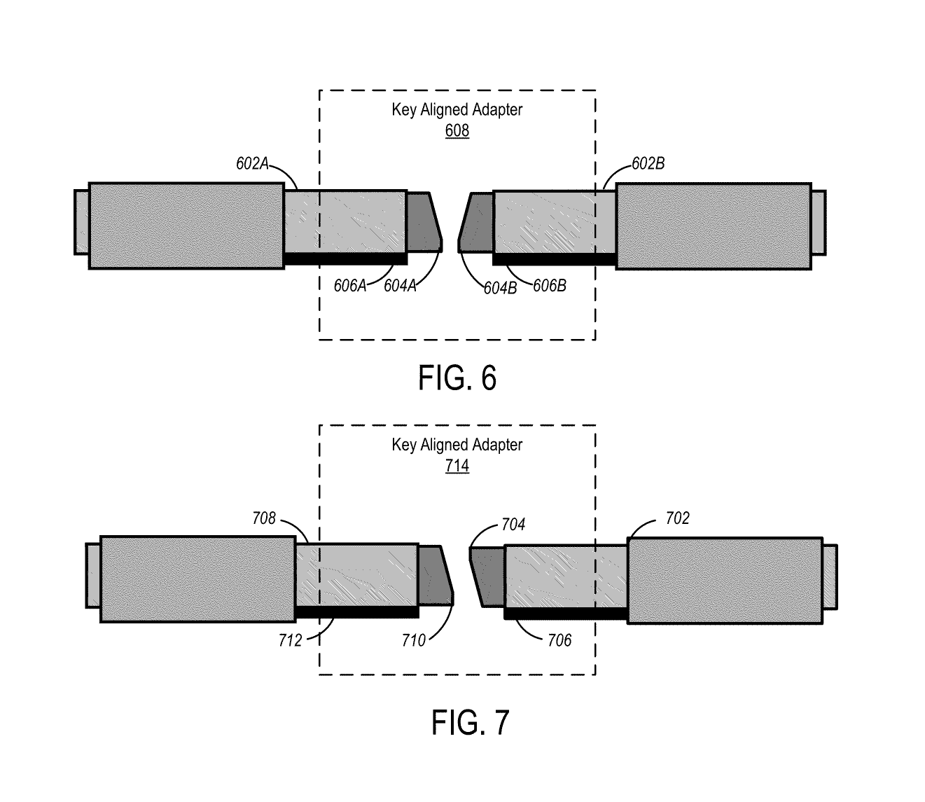

In the angled MPO terminations 402A and 402B of the TAP 110 from FIG. 4, the angle of the MPO terminations 402 is opposed to the key (the ferrule is flipped) so that there will be no gap. FIG. 7 illustrates an angled termination 702 from the TAP 110 of FIG. 4 (termination 402 from FIG. 3). The termination 704 includes an angled ferrule 704 and a key 706. The termination 704 here is different from those of FIG. 6 in that the angle of the ferrule 704 is opposed to the key 706 (the ferrule 704 has been flipped). As a result, a termination 708 of a cable will be able to connect with termination 702 through key aligned adapter 714 and the ferrule 710 of the termination 708 will align with the ferrule 704 of termination 702 without a gap.

Further, even though the ferrule 704 has been flipped, the fiber layout of the termination 702 is still a key aligned layout. For example, assume terminations 702 and 708 each include twelve fibers. Based on the key aligned layout, fiber one of termination 702 is aligned with fiber twelve of termination 708, fiber two of termination 702 is aligned with fiber eleven of termination 708, fiber three of termination 702 is aligned with fiber ten of termination 708, and so on.

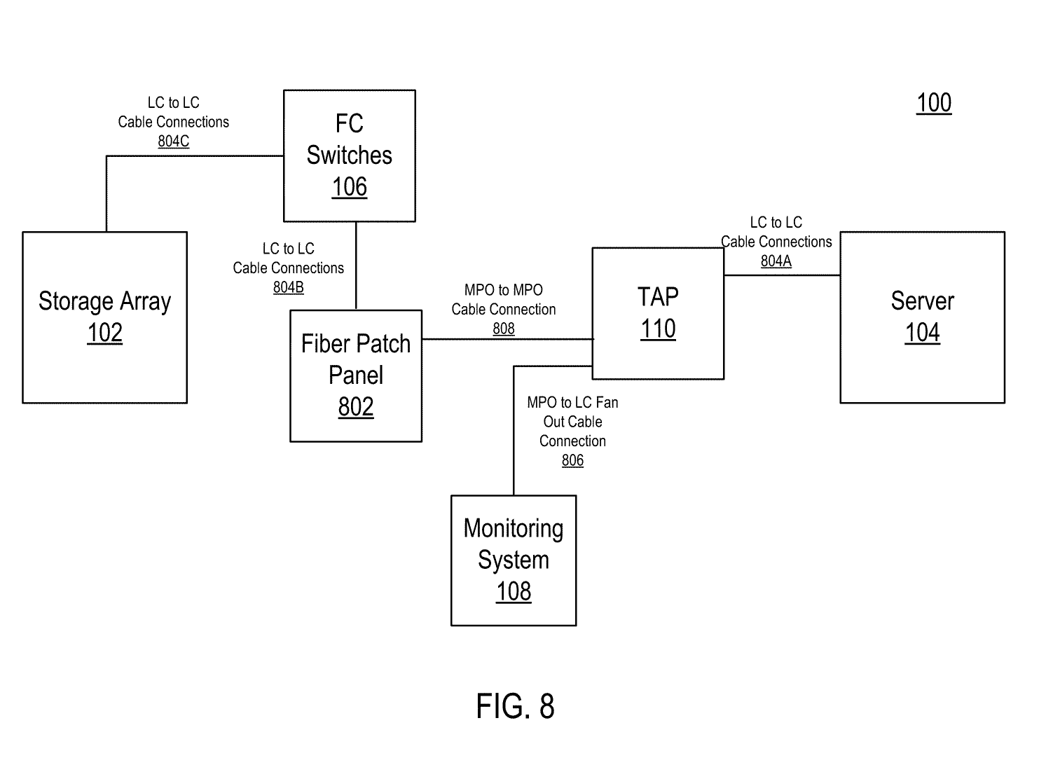

FIG. 8 illustrates the cable connections between the entities of the SAN 100 in view of the terminations of the TAP 110. LC to LC cable connections 804A connect the server 104 to the LC terminations 404A-404F of the TAP 110. An MPO to LC fan out cable connection 806 connects the APC multimode MPO termination 402A of the TAP 110 to the monitoring system 108. An angled MPO to MPO cable connection 808 connects an angled fiber patch panel 802 to the APC multimode MPO termination 402B of the TAP 110. In this example, the fiber patch panel 802 is included in the SAN 100 so that LC cable connections can be used to connect with the FC switches 106 (for converting from MPO to LC). LC to LC cable connections 804B connect the fiber patch panel 802 to the FC switches 106 and LC to LC cable connections 804C connect the FC switches 106 to the storage array 102.

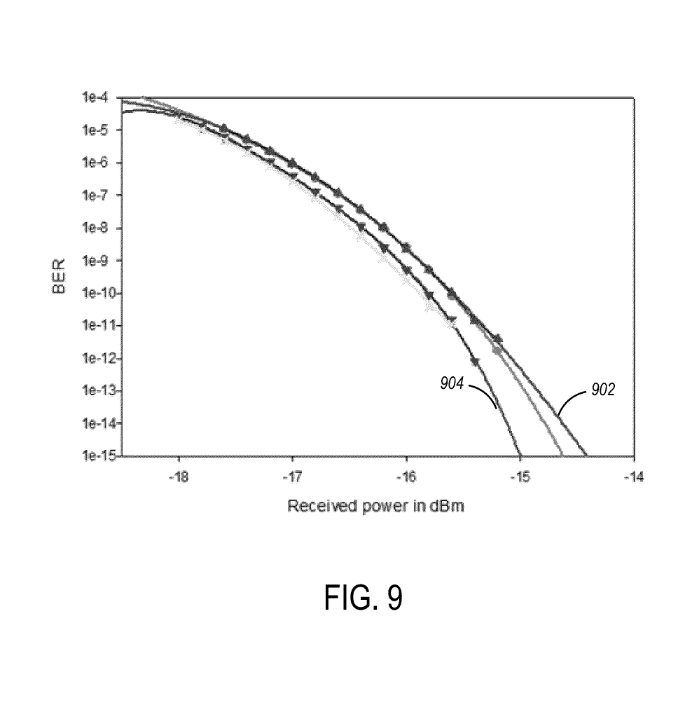

FIG. 9 is a plot of BER versus received power for APC MPO terminations and PC MPO terminations. Line 902 shows BER versus received power if the TAP 110 includes PC MPO terminations. Line 904 shows BER versus received power when the TAP 110 includes APC MPO terminations as described above. By using APC MPO terminations for the TAP 110 instead of PC MPO terminations, the BER rate as a function of received power improves by at least 0.5 db.

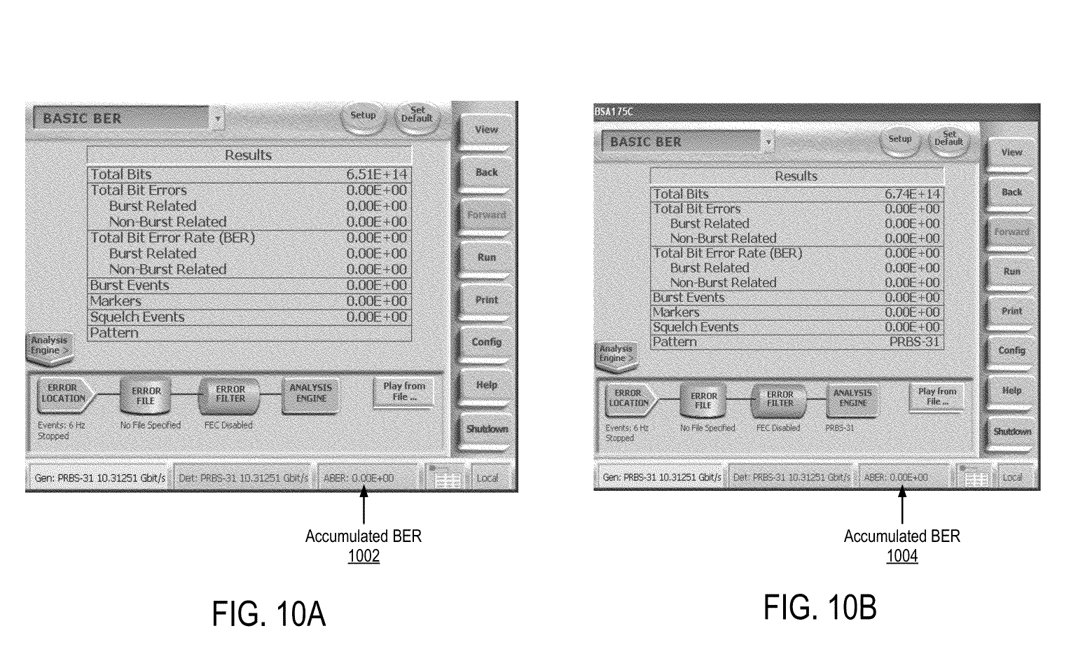

A soak test of the TAP 110 with the angled terminations showed that there are no encoded errors even after running for 15 hours. The TAP 110 can run for at least 18 hours without an error up to “6.51E+14 @−13.5” dBm. Hence, the TAP 110 can run up to BER of “1.53 E-15” without issues. FIG. 10A shows results of a stressed soak test at a received power of “−13” dBm and FIG. 10B shows the results of a stressed soak test at a received power of “−13.5” dBm. As can be seen, for both tests, the accumulated BER 1002 and 1004 @ 10 GE is zero, implying no error has occurred. Stressed applied in these tests is random jitter of “29%” UI and total jitter measured was “73%” UI with deterministic jitter (DJ) of “17.3%” UI. Further, angle polishing the multimode terminations improves the higher return loss at the terminations, thereby improving the RIN and the system performance at very high speed with a BER rate of “1 E-15” with very high confidence level of “>95%.”

### Additional Considerations

It is appreciated that the particular embodiment depicted in the figures represents but one choice of implementation. Other choices would be clear and equally feasible to those of skill in the art.

While the disclosure herein has been particularly shown and described with reference to a specific embodiment and various alternate embodiments, it will be understood by persons skilled in the relevant art that various changes in form and details can be made therein without departing from the spirit and scope of the disclosure.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for efficiently tracking network transactions over time through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A traffic access point (TAP) comprising:
a first angle polished multimode multiple-fiber push-on (MPO) termination configured to exchange signals with a first system, the first angle polished multimode MPO termination including a plurality of fibers in a key aligned layout; and
a second angle polished multimode MPO termination coupled to the first angle polished multimode MPO termination and configured to output to a second system a portion of a signal transmitted by the first system and received through the first angle polished multimode MPO, the second angle polished multimode MPO termination including a plurality of fibers in a key aligned layout.

2. The traffic access point of claim 1, wherein the first angle polished multimode MPO termination includes an angled ferrule and a key, the angle of the ferrule opposed to the key.

3. The traffic access point of claim 1, further comprising:
a first key aligned adapter coupled to the first angle polished MPO termination; and
a second key aligned adapter coupled to the second angle polished MPO termination.

4. The traffic access point of claim 1, further comprising:
an Lucent Connector (LC) termination configured to output a remainder of the signal received from the first system to a third system.

5. The traffic access point of claim 4, wherein the LC termination is an angle polished termination.

6. The traffic access point of claim 4, wherein the first system is a storage array, the second system is a monitoring system, and the third system is a server system.

7. The traffic access point of claim 4, wherein the portion of the signal is approximately 20% or 30% of the signal and the remainder is approximately 70% or 80% of the signal.

8. The traffic access point of claim 4, wherein:
the LC termination is further configured to receive a signal from the third system destined for the first system;
the second angle polished multimode MPO termination further configured to output a portion of the signal; and
the first second angle polished multimode MPO termination further configured to output a remainder of the signal received from the third system for receipt by the first system.

9. The traffic access point of claim 1, wherein the plurality of fibers are twelve fibers or a multiple of 12 fibers.

10. A method comprising:
receiving, by a traffic access point (TAP) through a first angle polished multimode multiple-fiber push-on (MPO) termination, a signal transmitted by a first system and destined for a third system;
splitting, by the TAP, the signal into a first portion and a second portion;
outputting, by the TAP through a second angle polished multimode MPO termination, the first portion to a second system; and
outputting, by the TAP through a third termination, the second portion to the third system.

11. The method of claim 10, wherein the first angle polished multimode MPO termination includes an angled ferrule and a key, the angle of the ferrule opposed to the key.

12. The method of claim 10, wherein a first key aligned adapter is coupled to the first angle polished MPO termination and a second key aligned adapter is coupled to the second angle polished MPO termination.

13. The method of claim 10, wherein the third termination is an LC termination.

14. The method of claim 10, wherein the third termination is an angle polished LC termination.

15. The method of claim 10, wherein the first system is a storage array, the second system is a monitoring system, and the third system is a server system.

16. The method of claim 10, wherein the first portion is approximately 30% of the signal and the second portion is approximately 70% of the signal.

17. The method of claim 10, wherein the first portion is approximately 20% of the signal and the second portion is approximately 80% of the signal.

18. The method of claim 10, further comprising:
receiving, by the TAP through the third termination, an additional signal from the third system destined for the first system;
splitting, by the TAP, the additional signal into a third portion and a fourth portion;
outputting, by the TAP through the second angle polished multimode MPO termination, the third portion to the second system; and
outputting, by the TAP through the first angle polished MPO termination, the fourth portion for receipt by the first system.

19. An angle polished multimode fiber push-on (MPO) termination comprising:
a plurality of multimode fibers;
a key; and
an angle polished ferrule, an angle of ferrule polishing opposed to the key.

20. The angle polished multimode MPO termination of claim 19, wherein the plurality of multimode fibers are in a key aligned layout.
